(19) United States
(12) Patent Application Publication
(10) Pub. No.: US 2026/0322259 A1
(43) Pub. Date: Oct. 15, 2026

(54) DC-DC Converter, ChIp, and ElectronIc DevIce

(71) Applicant: SG MICRO CORP, Beijing (CN)

(72) Inventors: Baoquan ZHANG, Beijing (CN); Duo LI, Beijing (CN)

(73) Assignee: SG MICRO CORP, Beijing (CN)

(21) Appl. No.: 18/880,307

(22) PCT Filed: Jun. 24, 2024
(86) PCT No.: PCT/CN2024/101020

§ 371 Date: Dec. 31, 2024

(30) Foreign Application Priority Data
Nov. 27, 2023 (CN) 202311595991.8

(51) Int. Cl. H02M 3/07; H02M 1/00; H02M 1/08; H02M 3/08

(52) U.S. Cl. CPC H02M 3/07; H02M 1/0067; H02M 1/0083; H02M 1/08; H02M 3/08

(57) ABSTRACT

A Direct Current (DC)-DC converter, a chip, and an electronic device are provided. The DC-DC converter includes a bootstrap boost circuit, a charge pump boost circuit, a high-side driver circuit, a low-side driver circuit, a high-side power transistor, and a low-side power transistor, wherein the bootstrap boost circuit provides a first boost voltage for the high-side driver circuit; the high-side driver circuit outputs a first high-side driving voltage to a control electrode of the high-side power transistor according to the first boost voltage; the charge pump boost circuit generates a second boost voltage through a charge pump, and outputs a second high-side driving voltage to the control electrode of the high-side power transistor based on the second boost voltage, wherein the second boost voltage is greater than the first boost voltage.

### CROSS REFERENCE TO THE RELATED APPLICATIONS

This application is the national phase entry of International Application No. PCT/CN2024/101020, filed on Jun. 24, 2024, which is based upon and claims priority to Chinese Patent Application No. 202311595991.8, filed on Nov. 27, 2023, the entire contents of which are incorporated herein by reference.

### TECHNICAL FIELD

The present disclosure relates to the technical field of integrated circuits, and in particular to a Direct Current (DC)-DC converter, a chip, and an electronic device.

### BACKGROUND

With the increasing expansion of the integrated circuit market, a DC-DC converter has developed rapidly. As a switching power supply technology, the DC-DC converter has the advantages of fast dynamic response and simple control, and has a wide range of applications.

At present, when an N-channel Metal Oxide Semiconductor (NMOS) is selected as a power transistor in a BUCK type DC-DC converter, a bootstrap capacitor is required to supply power to a driving part of the power transistor. However, in order to obtain a relatively low on-resistance of a high-side power transistor in the related art, a capacitance value and area of the bootstrap capacitor are often relatively large, resulting in a relatively high chip cost.

At present, no effective technical solution has been proposed to solve the problem that the chip cost is relatively high due to the fact that the capacitance value and area of the bootstrap capacitor in the BUCK type DC-DC converter are relatively large.

### SUMMARY

Embodiments described in the present disclosure provide a DC-DC converter, a chip, and an electronic device.

A first aspect of the present disclosure provides a DC-DC converter, including a bootstrap boost circuit, a charge pump boost circuit, a high-side driver circuit, a low-side driver circuit, a high-side power transistor, and a low-side power transistor. The bootstrap boost circuit is configured to provide a first boost voltage for the high-side driver circuit based on an input voltage of an input voltage end. The high-side driver circuit is configured to output a first high-side driving voltage to a control electrode of the high-side power transistor according to the first boost voltage based on a Pulse Width Modulation (PWM) signal at a modulation signal end. The charge pump boost circuit is configured to generate a second boost voltage through a charge pump, and output a second high-side driving voltage to the control electrode of the high-side power transistor according to the second boost voltage, where the second boost voltage is greater than the first boost voltage. The low-side driver circuit is configured to output a low-side driving voltage to a control electrode of the low-side power transistor based on the PWM signal at the modulation signal end. A first electrode of the high-side power transistor is coupled to the input voltage end, a second electrode of the high-side power transistor is coupled to a first electrode of the low-side power transistor through a switch node, the high-side power transistor is configured to be turned on or off according to the first high-side driving voltage and the second high-side driving voltage, and the low-side power transistor is configured to be turned on or off according to the low-side driving voltage. One end of the bootstrap boost circuit and one end of the charge pump boost circuit are respectively coupled to the switch node.

In one optional implementation of the present disclosure, the bootstrap boost circuit includes a first diode and a first bootstrap capacitor. A first end of the first diode is coupled to the input voltage end, and a second end of the first diode is respectively coupled to a first end of the first bootstrap capacitor and a first end of the high-side driver circuit through a first bootstrap node. A second end of the first bootstrap capacitor is respectively coupled to the switch node and a second end of the high-side driver circuit, and the first bootstrap capacitor is configured to be charged based on the input voltage when the PWM signal is at a low level, and provide the first boost voltage for the high-side driver circuit when the PWM signal is at a high level.

In one optional implementation of the present disclosure, the charge pump boost circuit includes the charge pump, a unidirectional rectifier circuit, a second bootstrap capacitor, and a high-voltage driver circuit. The charge pump is configured to charge the second bootstrap capacitor to N times the input voltage through the unidirectional rectifier circuit, where N is a positive integer greater than 1. A first end of the unidirectional rectifier circuit is coupled to the charge pump, and a second end of the unidirectional rectifier circuit is respectively coupled to a first end of the second bootstrap capacitor and a first end of the high-voltage driver circuit through a second bootstrap node. A second end of the second bootstrap capacitor is coupled to the switch node, and the second bootstrap capacitor is configured to be charged based on the charge pump when the PWM signal is at the low level, and provide the second boost voltage for the high-voltage driver circuit when the PWM signal is at the high level and a voltage of the switch node rises to the input voltage. A second end of the high-voltage driver circuit is coupled to the control electrode of the high-side power transistor, and the high-voltage driver circuit is configured to output the second high-side driving voltage to the control electrode of the high-side power transistor based on the second boost voltage.

In one optional implementation of the present disclosure, the unidirectional rectifier circuit includes a unidirectional on switch tube.

In one optional implementation of the present disclosure, the unidirectional rectifier circuit includes a second diode.

In one optional implementation of the present disclosure, when N is 3, the charge pump includes a digital receiver, a first transistor, a second transistor, and a third transistor. A first end of the digital receiver is coupled to the modulation signal end, a second end of the digital receiver is coupled to a bootstrap control signal end, a third end of the digital receiver is coupled to a control electrode of the first transistor, a fourth end of the digital receiver is coupled to a control electrode of the second transistor, and the digital receiver is configured to control the on or off of the first transistor and the second transistor according to the PWM signal at the modulation signal end and a bootstrap control signal of the bootstrap control signal end. A first electrode of the first transistor is respectively coupled to a first electrode of the second transistor, a first electrode of the third transistor, and the second end of the first bootstrap capacitor, a second electrode of the first transistor is respectively coupled to the input voltage end and the first end of the first diode, and a second electrode of the second transistor is grounded. A control electrode of the third transistor is coupled to the modulation signal end, a second electrode of the third transistor is coupled to the switch node, and the PWM signal at the modulation signal end controls the on or off of the third transistor.

In one optional implementation of the present disclosure, the high-voltage driver circuit includes a fourth transistor, a third diode, a fourth diode, and a third bootstrap capacitor. A first end of the third bootstrap capacitor is respectively coupled to a second end of the third diode, a first end of the fourth diode, and a control electrode of the fourth transistor, a second end of the third bootstrap capacitor is grounded, and the third bootstrap capacitor is configured to output a signal to the control electrode of the fourth transistor. A first electrode of the fourth transistor is coupled to the control electrode of the high-side power transistor, a second electrode of the fourth transistor is coupled to the second bootstrap node, and the fourth transistor is configured to be turned on or off according to a voltage difference between the control electrode and the second electrode of the fourth transistor. A first end of the third diode is respectively coupled to the first bootstrap node and a first end of the second diode, and a second end of the fourth diode is respectively coupled to a second end of the second diode and the second bootstrap node.

In one optional implementation of the present disclosure, when the PWM signal at the modulation signal end is at the low level, the bootstrap control signal at the bootstrap control signal end is a square signal, the first transistor and the second transistor are turned on, the third transistor is turned off, the high-side power transistor is turned off, the low-side power transistor is turned on, the first bootstrap capacitor is configured to charge the second bootstrap capacitor to twice the input voltage through the second diode, and charge the third bootstrap capacitor to twice the input voltage through the third diode, and the fourth transistor is turned off. When the PWM signal at the modulation signal end is at the high level, the first transistor and the second transistor are turned off, the third transistor is turned on, the high-side power transistor is turned on, the low-side power transistor is turned off, and a voltage of the switch node rises. When the voltage of the switch node rises to a preset threshold, the fourth transistor is turned on, and when the voltage of the switch node rises to the input voltage, a voltage of an upper plate of the second bootstrap capacitor is raised to 3 times the input voltage, where the preset threshold is less than the input voltage.

In one optional implementation of the present disclosure, the DC-DC converter further includes an output circuit. One end of the output circuit is coupled to the switch node, and the output circuit is configured to generate an output voltage. The output circuit includes an inductor, an output capacitor, an equivalent series resistor, and an output resistor. A first end of the inductor is coupled to the switch node, a second end of the inductor is respectively coupled to a first end of the equivalent series resistor, a first end of the output resistor, and the output voltage end, and an output voltage is generated at the output voltage end according to an inductor current flowing through the inductor. A second end of the equivalent series resistor is coupled to the first end of the output capacitor, and a second end of the output capacitor and a second end of the output resistor are grounded respectively.

In one optional implementation of the present disclosure,
the PWM signal is directly output to the control electrode of the high-side power transistor; or
the PWM signal is matched to a level converter of the high-side power transistor, and is output to the control electrode of the high-side power transistor through the level converter.

In one optional implementation of the present disclosure, the second high-side driving voltage is greater than the first high-side driving voltage.

In one optional implementation of the present disclosure, the first diode is a Schottky diode.

In one optional implementation of the present disclosure, the first transistor is an enhanced Metal Oxide Semiconductor (MOS) transistor with P-type compensation.

In one optional implementation of the present disclosure, the fourth transistor is an enhanced MOS transistor with P-type compensation, and the fourth transistor is a High Voltage P-channel Metal Oxide Semiconductor (HVPMOS) transistor.

A second aspect of the present disclosure provides a chip, including the DC-DC converter of any one in the first aspect.

A third aspect of the present disclosure provides an electronic device, including the chip in the second aspect.

In the DC-DC converter provided by the embodiments of the present disclosure, the charge pump boost circuit is introduced to generate the second boost voltage, which is greater than the first boost voltage provided by the bootstrap boost circuit; and the high-side driver circuit outputs the first high-side driving voltage to the control electrode of the high-side power transistor according to the first boost voltage, the charge pump boost circuit outputs the second high-side driving voltage to the control electrode of the high-side power transistor according to the second boost voltage, and the output second high-side driving voltage is greater than the first high-side driving voltage, thereby increasing a voltage of the control electrode of the high-side power transistor. In the present disclosure, the second boost voltage greater than the first boost voltage is generated through the charge pump boost circuit, and the voltage of the control electrode of the high-side power transistor is further increased, so that a relatively small bootstrap capacitor obtains a relatively high gate-source voltage of the high-side power transistor, the capacitance value of the built-in bootstrap capacitor of the DC-DC converter is reduced, the area of the built-in bootstrap capacitor is reduced, the chip cost is further reduced, and the problem that the chip cost is relatively high due to the fact that the capacitance value and area of the bootstrap capacitor in the BUCK type DC-DC converter are relatively large is solved.

### BRIEF DESCRIPTION OF THE DRAWINGS

In order to more clearly illustrate the specific implementations of the present disclosure or the technical solutions in the related art, the drawings used in the description of the specific implementations or the related art will be briefly described below. It is apparent that the drawings described below are only some embodiments of the present disclosure and not intended to limit the present disclosure. Other drawings may further be obtained by those of ordinary skill in the art according to these drawings without creative efforts.

FIG. 1 is a circuit diagram of a BUCK type DC-DC converter in the related art.

FIG. 2 is an exemplary block diagram of a DC-DC converter provided by an embodiment of the present disclosure.

FIG. 3 is an exemplary circuit diagram of a DC-DC converter provided by an embodiment of the present disclosure.

FIG. 4 is an exemplary circuit diagram of a DC-DC converter provided by another embodiment of the present disclosure.

### DETAILED DESCRIPTION OF THE EMBODIMENTS

In order to make the purpose, technical solutions, and advantages of the embodiments of the present disclosure clearer, the technical solutions in the embodiments of the present disclosure will be described clearly and completely below with reference to the drawings. It is apparent that the described embodiments are part rather than all embodiments of the present disclosure. On the basis of the description of the embodiments of the present disclosure, all other embodiments obtained by those skilled in the art without creative work shall fall within the scope of protection of the present disclosure.

Unless otherwise defined, all terms used herein (including technical and scientific terms) have the same meanings as those commonly understood by those skilled in the art that the subject of the present disclosure belongs. Further, it is to be understood that terms such as those defined in commonly used dictionaries should be interpreted as having the meanings consistent with those in the context of the specification and related technologies, and will not be interpreted in an idealized or overly formal form, unless otherwise defined herein. As used herein, the statement that two or more parts are “connected” or “coupled” together shall mean that these parts are combined directly or through one or more intermediate parts.

In all embodiments of the present disclosure, since a source and a drain of an MOS transistor are symmetrical, and on current directions between the sources and the drains of an N-type transistor and a P-type transistor are opposite, in the embodiments of the present disclosure, a controlled middle end of the MOS transistor is referred to as a control electrode, and the remaining two ends of the MOS transistor are referred to as a first electrode and a second electrode, respectively. The transistors used in the embodiments of the present disclosure are mainly switching transistors. In addition, for the convenience of unified expression, in the context, a base of a Bipolar Junction Transistor (BJT) is referred to as the control electrode, an emitter of the BJT is referred to as the first electrode, and a collector of the BJT is referred to as the second electrode. In addition, terms such as “first” and “second” are only used for distinguishing one component (or one part of a component) from another component (or another part of a component).

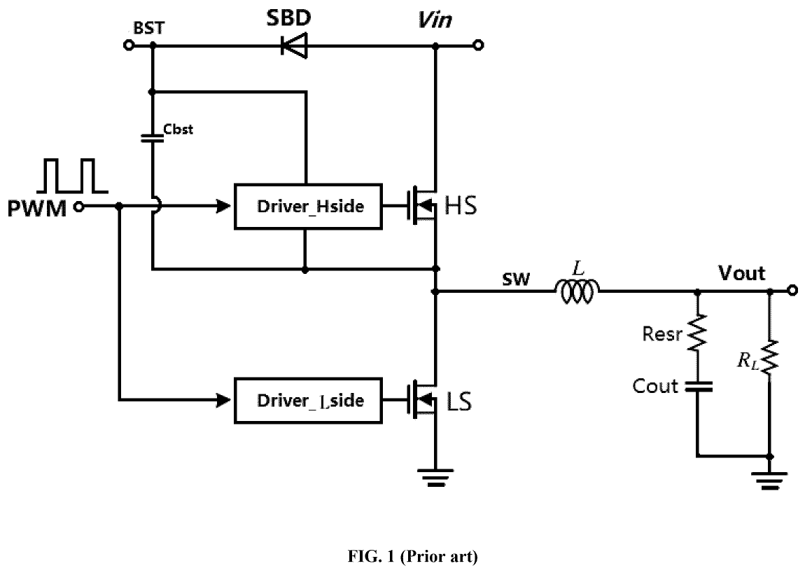

At present, when an NMOS is selected as a power transistor in a BUCK type DC-DC converter, a bootstrap capacitor (BST capacitor) is required to supply power to a driving part of the power transistor. FIG. 1 shows a circuit diagram of a low-voltage BUCK type DC-DC converter in the related art, where a PWM signal is a PWM signal, Vin is an input voltage, the input voltage is a low voltage with the magnitude of 2.5 V to 5.5 V, Vout is an output voltage, SBD is a Schottky diode, BST and SW respectively represent a bootstrap node and a switch node in the circuit, Cbst is a bootstrap capacitor, Driver_Hside is a high-side driver circuit, HS is a high-side power transistor, Driver_Lside is a low-side driver circuit, LS is a low-side power transistor, L is an inductor, Cout is an output capacitor, Resr is an equivalent series resistor, and R_{L} is an output resistor.

In order to obtain a relatively low on-resistance of the high-side power transistor HS, a capacitance value of the bootstrap capacitor Cbst is usually relatively large. The conventional solution is to add a bootstrap capacitor Cbst. In this case, a chip needs to add a BST pin. In order to avoid adding the BST pin, the bootstrap capacitor Cbst is built-in in the related art.

Since the on-resistance of the MOS transistor is in inverse proportion to a gate-source voltage Vgs thereof, a higher gate-source voltage Vgs is required to obtain a lower on-resistance of the MOS transistor under the same area of the MOS transistor. The gate-source voltage Vgs of the high-side power transistor HS in the BUCK type DC-DC converter with the built-in bootstrap capacitor Cbst may be obtained by the following calculation method:
1. Assuming that the total charge of the high-side power transistor HS is Qt, and the voltage after driving is Vgs, then Qt-Vgs*Cgs, and an equivalent gate capacitance Cgs may be obtained.
2. After the bootstrap capacitor Cbst is charged by the input voltage Vin, the voltage is Vin. Assuming that the driver stage loss is ignored, the bootstrap capacitor Cbst is used directly to provide the driving voltage for a gate of HS, and a charge share process may be obtained:
Vin*Cbst=Vgs*(Cgs+Cbst), that is, the gate-source voltage Vgs is Vgs=Vin*Cbst/(Cgs+Cbst).

It may be seen that if Cgs=Cbst, then Vgs=½*Vin may be obtained. If a higher Vgs is to be obtained, a larger bootstrap capacitor Cbst is required.

However, since the capacitance value is in direct proportion to the area of a capacitor plate, the larger the capacitance value of the bootstrap capacitor Cbst, the larger the area of the bootstrap capacitor Cbst, and the relatively large area of the bootstrap capacitor Cbst may result in a relatively high chip cost.

The inventor has found that in order to reduce the chip cost, it is necessary to reduce or optimize the area of the built-in bootstrap capacitor, reduce or avoid increasing the capacitance value of the bootstrap capacitor Cbst, and obtain a relatively high gate-source voltage Vgs of the high-side power transistor HS with a relatively small bootstrap capacitor Cbst, thereby obtaining a relatively low on-resistance of the high-side power transistor HS. Therefore, how to obtain the relatively high gate-source voltage Vgs of the high-side power transistor HS with the relatively small bootstrap capacitor Cbst is urgently needed.

Regarding the charge share process in the above calculation method, if the capacitance value of the bootstrap capacitor Cbst is doubled, that is, Cbst=2*Cgs, then Vgs=⅔*Vin may be obtained. If the initial voltage of the bootstrap capacitor Cbst is doubled, that is, the initial voltage is 2*Vin, then Vgs=2*Vin*Cbst/(Cgs+Cbst)=Vin may be obtained, and the obtained gate-source voltage Vgs is also doubled.

It may be seen from the above analysis that the initial voltage of the bootstrap capacitor Cbst is increased more effectively than the increase of the area of the bootstrap capacitor Cbst for the gate-source voltage Vgs of the high-side power transistor HS.

Therefore, in the embodiments of the present disclosure, a built-in second bootstrap capacitor C_BST2 is added based on an original first bootstrap capacitor C_BST1. Compared with the initial voltage of the original first bootstrap capacitor C_BST1, the initial voltage of the second bootstrap capacitor C_BST2 is increased through a charge pump in a charge pump boost circuit, the second bootstrap capacitor C_BST2 uses a higher initial voltage, more charges may be shared during the driving process under the same capacitor area, and the driving voltage of the gate of the high-side power transistor HS is higher. In the embodiments of the present disclosure, a higher initial voltage is provided for the second bootstrap capacitor C_BST2, so that the area of the second bootstrap capacitor C_BST2 is smaller on the premise of obtaining the same gate-source voltage Vgs of the high-side power transistor HS, thereby achieving the optimized design of the area of the built-in bootstrap capacitor and reducing the chip cost.

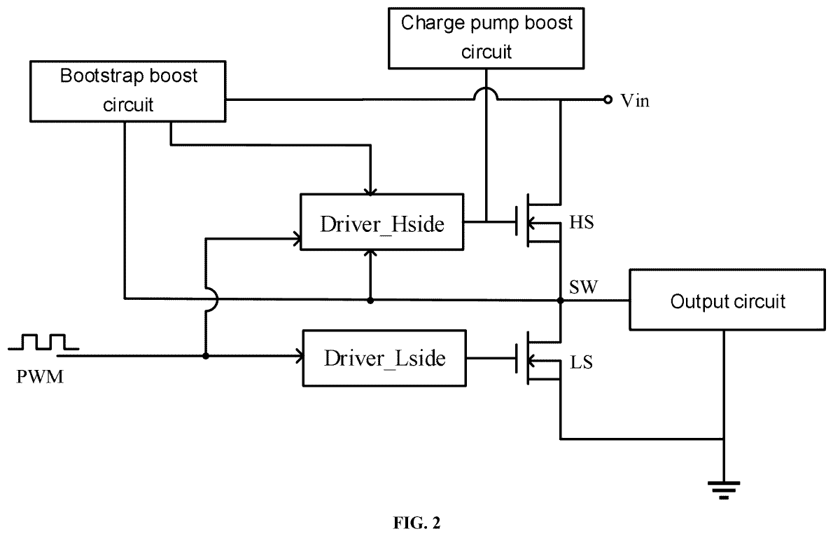

The embodiments of the present disclosure provide a DC-DC converter, an exemplary block diagram of which is as shown in FIG. 2, including a bootstrap boost circuit, a charge pump boost circuit, a high-side driver circuit Driver_Hside, a low-side driver circuit Driver_Lside, a high-side power transistor HS, and a low-side power transistor LS.

The bootstrap boost circuit is configured to provide a first boost voltage for the high-side driver circuit Driver_Hside based on an input voltage Vin of an input voltage end.

The high-side driver circuit Driver_Hside is configured to output a first high-side driving voltage to a control electrode of the high-side power transistor HS according to the first boost voltage based on a PWM signal at a modulation signal end. The PWM signal may be directly output to the control electrode of the high-side power transistor HS, and may also be matched to a level converter of the high-side power transistor HS, and is output to the control electrode of the high-side power transistor HS through the level converter, and the control electrode corresponds to a gate of an MOS transistor.

The charge pump boost circuit is configured to generate a second boost voltage through a charge pump, and output a second high-side driving voltage to the control electrode of the high-side power transistor according to the second boost voltage, where the second boost voltage is greater than the first boost voltage. The second boost voltage greater than the first boost voltage is generated through the charge pump boost circuit, so that a relatively small bootstrap capacitance value obtains a relatively high gate-source voltage Vgs of the high-side power transistor HS, and then a relatively low on-resistance of the high-side power transistor HS is obtained. The second high-side driving voltage output to the control electrode of the high-side power transistor HS according to the second boost voltage is greater than the first high-side driving voltage output to the control electrode of the high-side power transistor HS according to the first boost voltage.

The low-side driver circuit Driver_Lside is configured to output a low-side driving voltage to a control electrode of the low-side power transistor LS based on the PWM signal at the modulation signal end.

A first electrode of the high-side power transistor HS is coupled to the input voltage end, a second electrode of the high-side power transistor HS is coupled to a first electrode of the low-side power transistor LS through a switch node, the high-side power transistor HS is configured to be turned on or off according to the first high-side driving voltage and the second high-side driving voltage, and the low-side power transistor LS is configured to be turned on or off according to the low-side driving voltage. A second electrode of the low-side power transistor LS is grounded.

One end of the bootstrap boost circuit and one end of the charge pump boost circuit are respectively coupled to the switch node SW.

The DC-DC converter as shown in FIG. 2 further includes an output circuit. One end of the output circuit is coupled to the switch node SW, and the output circuit is further configured to generate an output voltage.

In the embodiments of the present disclosure, on the premise of obtaining the same gate-source voltage of the high-side power transistor, the area of the bootstrap capacitor may be greatly reduced by increasing the starting voltage through the charge pump in the charge pump boost circuit, the same gate-source voltage of the high-side power transistor is obtained through the smallest bootstrap capacitor, the optimized design of the area of the built-in bootstrap capacitor is achieved, and the chip cost is reduced.

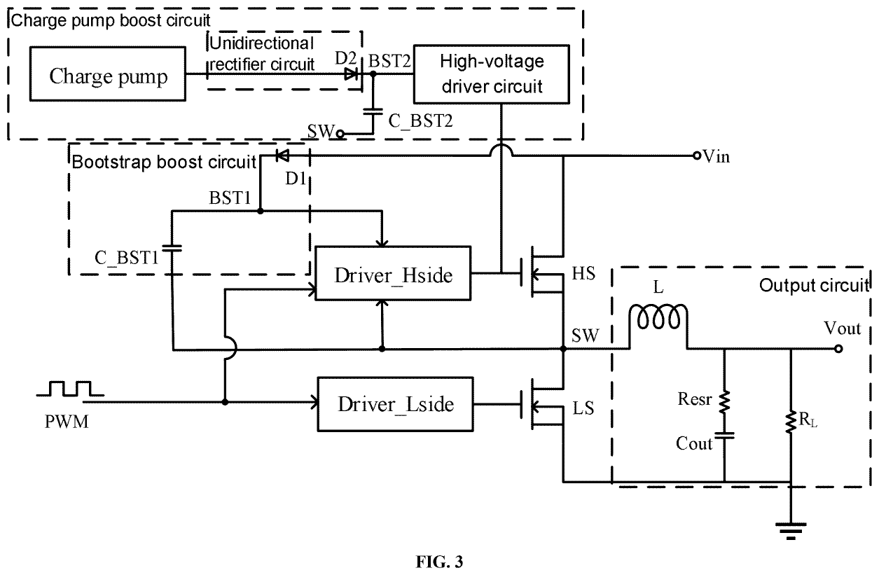

An exemplary circuit diagram of a DC-DC converter provided by an embodiment of the present disclosure is as shown in FIG. 3, in which the bootstrap boost circuit includes a first diode D1 and a first bootstrap capacitor C_BST1. The first diode D1 may be a Schottky diode.

A first end of the first diode DI is coupled to the input voltage end, and a second end of the first diode DI is respectively coupled to a first end of the first bootstrap capacitor C_BST1 and a first end of the high-side driver circuit Driver_Hside through a first bootstrap node BST1.

A second end of the first bootstrap capacitor C_BST1 is respectively coupled to the switch node SW and a second end of the high-side driver circuit Driver_Hside, and the first bootstrap capacitor C_BST1 is configured to be charged based on the input voltage Vin when the PWM signal is at a low level, and provide the first boost voltage for the high-side driver circuit Driver Hside when the PWM signal is at a high level.

The first diode D1 plays a rectifying role. When the PWM signal is at the high level, the high-side power transistor HS is turned on, the low-side power transistor LS is turned off, the voltage at the switch node SW is Vin, the voltage of an upper plate of the first bootstrap capacitor C_BST1 is raised to be greater than Vin, and the first diode D1 may prevent the upper plate of the first bootstrap capacitor C_BST1 from discharging to the input voltage end.

In FIG. 3, the charge pump boost circuit includes the charge pump, a unidirectional rectifier circuit, a second bootstrap capacitor C_BST2, and a high-voltage driver circuit.

The charge pump is configured to charge the second bootstrap capacitor C_BST2 to N times the input voltage Vin through the unidirectional rectifier circuit, where N is a positive integer greater than 1. On the premise of obtaining the same gate-source voltage Vgs of the high-side power transistor HS, the higher the initial voltage N*Vin by which the charge pump charges the second bootstrap capacitor C_BST2 is, the smaller the area of the second bootstrap capacitor C_BST2 is.

A first end of the unidirectional rectifier circuit is coupled to the charge pump, and a second end of the unidirectional rectifier circuit is respectively coupled to a first end of the second bootstrap capacitor C_BST2 and a first end of the high-voltage driver circuit through a second bootstrap node BST2.

A second end of the second bootstrap capacitor C_BST2 is coupled to the switch node SW, and the second bootstrap capacitor C_BST2 is configured to be charged based on the charge pump when the PWM signal is at the low level, and provide the second boost voltage for the high-voltage driver circuit when the PWM signal is at the high level and a voltage of the switch node SW rises to the input voltage Vin.

A second end of the high-voltage driver circuit is coupled to the control electrode of the high-side power transistor HS, and the high-voltage driver circuit is configured to output the second high-side driving voltage to the control electrode of the high-side power transistor HS based on the second boost voltage.

Specifically, when the PWM signal is at the low level, the charge pump charges the second bootstrap capacitor C_BST2. When the PWM signal is at the high level, the first bootstrap capacitor C_BST1 initially supplies power to the high-side driver circuit Driver_Hside, so as to provide the first boost voltage for the high-side driver circuit Driver_Hside to drive the high-side power transistor HS, so that the high-side power transistor HS is turned on, the low-side power transistor LS is turned off, the voltage at the switch node SW starts to rise, and the voltage at the first bootstrap node BST1 and the voltage at the second bootstrap node BST2 are gradually raised.

When the PWM signal is at the high level and the voltage at the switch node SW rises to Vin, the second bootstrap capacitor C_BST2 supplies power to the high-voltage driver circuit, so as to provide the second boost voltage for the high-voltage driver circuit. The high-voltage driver circuit then outputs the second high-side driving voltage to the control electrode of the high-side power transistor HS to drive the high-side power transistor HS, and raise the voltage at the first bootstrap node BST1 and the voltage at the second bootstrap node BST2 by 1 Vin.

In one optional implementation of the present disclosure, the unidirectional rectifier circuit includes a unidirectional on switch tube. The unidirectional rectifier circuit may be a unidirectional on switch tube controlled by appropriate logic.

In FIG. 3, the unidirectional rectifier circuit includes a second diode D2. The unidirectional rectifier circuit may also be the second diode D2.

In FIG. 3, the output circuit includes an inductor L, an output capacitor Cout, an equivalent series resistor Resr, and an output resistor RL. The equivalent series resistor Resr is a parasitic resistor of the output capacitor Cout.

A first end of the inductor L is coupled to the switch node SW, a second end of the inductor L is respectively coupled to a first end of the equivalent series resistor Resr, a first end of the output resistor RL and the output voltage end, and an output voltage Vout is generated at the output voltage end according to an inductor current flowing through the inductor L.

A second end of the equivalent series resistor Resr is coupled to the first end of the output capacitor Cout, and a second end of the output capacitor Cout and a second end of the output resistor RL are grounded respectively.

The working principle of the DC-DC converter is described below with reference to the exemplary circuit diagram of the DC-DC converter in FIG. 3.

During the Toff period, the PWM signal is at the low level, the high-side power transistor HS is turned off, the low-side power transistor LS is turned on, the voltage at the switch node SW is 0, and the charge pump charges the second bootstrap capacitor C_BST2 to N*Vin, where N is a positive number greater than 1, such as 2, 3, 4 or 5. On the premise of obtaining the same gate-source voltage Vgs of the high-side power transistor HS, the higher the initial voltage N*Vin by which the charge pump charges the second bootstrap capacitor C_BST2 is, the smaller the area of the second bootstrap capacitor C_BST2 is.

During the Ton period, the PWM signal is at the high level, the high-side power transistor HS is turned on, and the low-side power transistor LS is turned off. Initially, the first bootstrap capacitor C_BST1 provides the first boost voltage for the high-side driver circuit Driver Hside to supply power to the high-side driver circuit Driver_Hside, and the high-side driver circuit Driver_Hside outputs the first high-side driving voltage to the gate of the high-side power transistor HS until the voltage at the switch node SW rises to Vin. At this time, the second bootstrap capacitor C_BST2 provides the second boost voltage for the high-voltage driver circuit to supply power to the high-voltage driver circuit, and the high-voltage driver circuit outputs the second high-side driving voltage to the gate of the high-side power transistor HS.

On the premise of obtaining the same gate-source voltage Vgs of the high-side power transistor HS, the charge pump charges the second bootstrap capacitor C_BST2 to N*Vin, which increases the starting voltage of the second bootstrap capacitor C_BST2, may greatly reduce the area of the second bootstrap capacitor C_BST2, obtain the same gate-source voltage Vgs of the high-side power transistor HS with the smallest second bootstrap capacitor C_BST2, and achieve the optimized design of the area of the built-in second bootstrap capacitor C_BST2, that is, the optimized design of the area of the built-in bootstrap capacitor is completed.

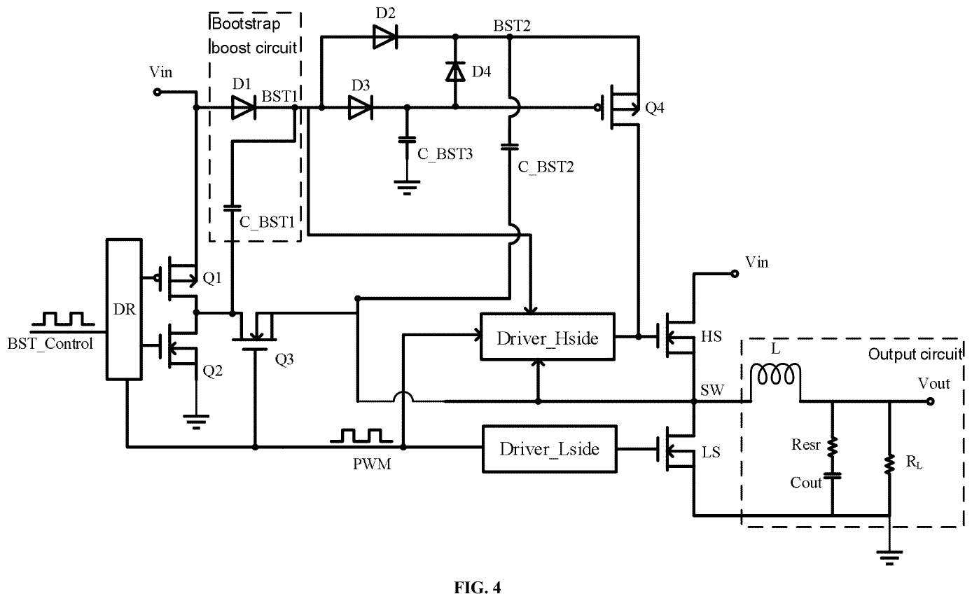

In one optional embodiment of the present disclosure, for the initial voltage N*Vin for charging the second bootstrap capacitor C_BST2, when N is 3, an exemplary circuit diagram of the DC-DC converter is as shown in FIG. 4, in which the charge pump includes a digital receiver DR, a first transistor P1, a second transistor P2, and a third transistor P3.

Specifically, the first transistor P1 is an enhanced MOS transistor with P-type compensation, which separates a P-type background region from an N-type channel region, thereby preventing the reverse breakdown of a PN junction and improving the stability and controllability of the MOS transistor.

A first end of the digital receiver DR is coupled to the modulation signal end, a second end of the digital receiver DR is coupled to a bootstrap control signal end, a third end of the digital receiver DR is coupled to a control electrode of the first transistor P1, a fourth end of the digital receiver DR is coupled to a control electrode of the second transistor P2, and the digital receiver DR is configured to control the on or off of the first transistor P1 and the second transistor P2 according to the PWM signal at the modulation signal end and a bootstrap control signal BST Control at the bootstrap control signal end.

A first electrode of the first transistor P1 is respectively coupled to a first electrode of the second transistor P2, a first electrode of the third transistor P3, and the second end of the first bootstrap capacitor C_BST1, a second electrode of the first transistor P1 is respectively coupled to the input voltage end and the first end of the first diode D1, and a second electrode of the second transistor P2 is grounded.

A control electrode of the third transistor P3 is coupled to the modulation signal end, a second electrode of the third transistor P3 is coupled to the switch node SW, and the PWM signal at the modulation signal end controls the on or off of the third transistor P3.

In FIG. 4, the high-voltage driver circuit includes a fourth transistor P4, a third diode D3, a fourth diode D4, and a third bootstrap capacitor C_BST3. The fourth transistor P4 is an enhanced MOS transistor with P-type compensation, which separates the P-type background region from the N-type channel region, thereby preventing the reverse breakdown of the PN junction and improving the stability and controllability of the MOS transistor. In addition, the fourth transistor P4 is an HVPMOS transistor. In the embodiments of the present disclosure, assuming that the forward voltage drop of each diode is 0, when the application scenario requires accurate calculation, the forward voltage drop of each diode may be assigned a value.

A first end of the third bootstrap capacitor C_BST3 is respectively coupled to a second end of the third diode D3, a first end of the fourth diode D4, and a control electrode of the fourth transistor P4, a second end of the third bootstrap capacitor C_BST3 is grounded, and the third bootstrap capacitor C_BST3 is configured to output a signal to the control electrode of the fourth transistor P4.

A first electrode of the fourth transistor P4 is coupled to the control electrode of the high-side power transistor HS, a second electrode of fourth transistor P4 is coupled to the second bootstrap node BST2, and the fourth transistor P4 is configured to be turned on or off according to a voltage difference between the control electrode and the second electrode of the fourth transistor P4.

A first end of the third diode D3 is respectively coupled to the first bootstrap node BST1 and a first end of the second diode D2, and a second end of the fourth diode D4 is respectively coupled to a second end of the second diode D2 and the second bootstrap node BST2.

In one optional embodiment of the present disclosure, when the PWM signal at the modulation signal end is at the low level, the bootstrap control signal BST_Control at the bootstrap control signal end is a square signal, the first transistor P1 and the second transistor P2 are turned on, the third transistor P3 is turned off, the high-side power transistor HS is turned off, the low-side power transistor LS is turned on, the first bootstrap capacitor C_BST1 is configured to charge the second bootstrap capacitor C_BST2 to twice the input voltage Vin through the second diode D2, and charge the third bootstrap capacitor C_BST3 to twice the input voltage Vin through the third diode D3, and the fourth transistor P4 is turned off.

When the PWM signal at the modulation signal end is at the high level, the first transistor P1 and the second transistor P2 are turned off, the third transistor P3 is turned on, the high-side power transistor HS is turned on, the low-side power transistor LS is turned off, and a voltage of the switch node SW rises. When the voltage of the switch node SW rises to a preset threshold, the fourth transistor P4 is turned on, and when the voltage of the switch node SW rises to the input voltage Vin, a voltage of an upper plate of the second bootstrap capacitor C_BST2 is raised to 3 times the input voltage Vin, where the preset threshold is less than the input voltage Vin.

The working principle of the DC-DC converter is described below with reference to the exemplary circuit diagram of the DC-DC converter in FIG. 4.

In FIG. 4, assuming that the forward voltage drop of each diode is 0, when the application scenario requires accurate calculation of the forward voltage drop of each diode, the forward voltage drop of each diode may be assigned a value. In the low-voltage BUCK type DC-DC converter, the input voltage Vin is 2.5 V to 5 V. For the initial voltage N*Vin charged to the second bootstrap capacitor C_BST2, when the initial voltage N*Vin is 3*Vin, the working principle of the DC-DC converter is as follows.

During the Toff period, the PWM signal is at the low level, the bootstrap control signal BST Control is set to the square signal, the first transistor P1 and the second transistor P2 are turned on, the third transistor P3 is turned off, the high-side power transistor HS is turned off, and the low-side power transistor LS is turned on; and the first bootstrap capacitor C_BST1 charges the second bootstrap capacitor C_BST2 and the third bootstrap capacitor C_BST3 to 2*Vin, the voltages of the upper plates of the second bootstrap capacitor C_BST2 and the third bootstrap capacitor C_BST3 are both the voltage at the first bootstrap node BST1, that is, 2*Vin, the third bootstrap capacitor C_BST3 controls the gate voltage Vg of the fourth transistor P4, and the gate-source voltage Vgs of the fourth transistor P4 is 0, so it is always in a closed state.

At the early stage of Ton, after the PWM signal changes from the low level to the high level, the first transistor P1 and the second transistor P2 are turned off, and the third transistor P3 is turned on, and the first bootstrap capacitor C_BST1 supplies power to the driving stage of the high-side power transistor HS, so that the driving voltage is output to the gate of the high-side power transistor HS, the high-side power transistor HS is turned on, the low-side power transistor LS is turned off, and the voltage at the switch node SW gradually rises to Vin; and when the voltage at the switch node SW rises, the voltage at the second bootstrap node BST2 is raised, and when the voltage at the second bootstrap node BST2 is higher than the gate voltage Vg of the third transistor P4 by a preset threshold value Vgs(th), the fourth transistor P4 is turned on, the second bootstrap capacitor C_BST2 outputs the driving voltage to the gate of the high-side power transistor HS, and the voltage at the second bootstrap node BST2 may reach up to 3*Vin. At this time, the voltage of the upper plate of the second bootstrap capacitor C_BST2 is raised to 3*Vin, and the voltage of the upper plate of the third bootstrap capacitor C_BST3 is still 2*Vin.

According to the embodiments of the present disclosure, an extremely simple circuit structure is adopted to meet the requirement of 3*Vin to provide the driving voltage for the high-side power transistor HS. On the premise of obtaining the same gate-source voltage Vgs of the high-side power transistor HS, the area of the bootstrap capacitor Cbst may be greatly reduced to reduce the chip cost.

The embodiments of the present disclosure further provide a chip, including the DC-DC converter according to the embodiments of the present disclosure. The chip may be a chip with an embedded efuse IP.

The embodiments of the present disclosure further provide an electronic device, including the chip according to the embodiments of the present disclosure. The electronic device may be a programming device.

It may be seen from the above description that the present disclosure achieves the following technical effects:

In the present disclosure, the second boost voltage greater than the first boost voltage is generated through the charge pump boost circuit, and the voltage of the control electrode of the high-side power transistor is further increased, so that a relatively small bootstrap capacitor obtains a relatively high gate-source voltage of the high-side power transistor, the capacitance value of the built-in bootstrap capacitor of the DC-DC converter is reduced, the area of the built-in bootstrap capacitor is reduced, the chip cost is further reduced, and the problem that the chip cost is relatively high due to the fact that the capacitance value and area of the bootstrap capacitor in the BUCK type DC-DC converter are relatively large is solved.

In the present disclosure, on the premise of obtaining the same gate-source voltage of the high-side power transistor, the capacitance value of the bootstrap capacitor may be reduced by increasing the starting voltage through the charge pump. Since the capacitance value is in direct proportion to the area of the capacitor plate, the area of the bootstrap capacitor may be reduced, the area of the built-in bootstrap capacitor may be optimized, and then the chip cost may be reduced.

The flowcharts and block diagrams in the drawings illustrate the architecture, functionality, and operation of apparatus and method that may be realized according to various embodiments of the present disclosure. In this regard, each block in the flowchart or block diagram may represent a module, a program segment or a portion of an instruction, which includes one or more executable instructions for implementing the specified logic function. In some alternative implementations, the functions marked in the blocks may also occur in a different order from those marked in the drawings. For example, two blocks shown in succession may, in fact, be executed substantially in parallel, and sometimes in a reverse order, depending upon the functionality involved. It is also to be noted that each block in the block diagram and/or flowchart, and a combination of blocks in the block diagram and/or flowchart may be implemented by a special purpose hardware-based system which performs a specified function or operation, or a combination of special purpose hardware and computer instructions.

Unless otherwise indicated clearly in the context, the singular form of terms used herein and in the appended claims includes the plural, and vice versa. Therefore, when referring to the singular, it usually includes the plural of the corresponding term. Similarly, the words “include” and “comprise” will be interpreted as inclusive rather than exclusive. Similarly, the terms “include” and “or” shall be interpreted as including, unless such interpretation is expressly prohibited herein. Where the term “example” is used herein, particularly when it is behind a group of terms, the “example” is only exemplary and illustrative, and should not be considered exclusive or extensive.

Further aspects and scope become apparent from the description provided herein. It is to be understood that various aspects of the present disclosure may be implemented separately or in combination with one or more other aspects. It is also to be understood that the description and specific embodiments herein are for illustrative purposes only and are not intended to limit the scope of the present disclosure.

The implementations of the present disclosure are described with reference to the drawings, those skilled in the art may make various modifications and variations without departing from the spirit and scope of the present disclosure, and such modifications and variations are all within the scope defined by the appended claims.

What is claimed is:

1. A Direct Current (DC)-DC converter, comprising a bootstrap boost circuit, a charge pump boost circuit, a high-side driver circuit, a low-side driver circuit, a high-side power transistor, and a low-side power transistor; wherein
the bootstrap boost circuit is configured to provide a first boost voltage for the high-side driver circuit based on an input voltage of an input voltage end;
the high-side driver circuit is configured to output a first high-side driving voltage to a control electrode of the high-side power transistor according to the first boost voltage based on a Pulse Width Modulation (PWM) signal at a modulation signal end;
the charge pump boost circuit is configured to generate a second boost voltage through a charge pump, and output a second high-side driving voltage to the control electrode of the high-side power transistor according to the second boost voltage, wherein the second boost voltage is greater than the first boost voltage;
the low-side driver circuit is configured to output a low-side driving voltage to a control electrode of the low-side power transistor based on the PWM signal at the modulation signal end;
a first electrode of the high-side power transistor is coupled to the input voltage end, a second electrode of the high-side power transistor is coupled to a first electrode of the low-side power transistor through a switch node, the high-side power transistor is configured to be turned on or off according to the first high-side driving voltage and the second high-side driving voltage, and the low-side power transistor is configured to be turned on or off according to the low-side driving voltage; and
one end of the bootstrap boost circuit and one end of the charge pump boost circuit are respectively coupled to the switch node.

2. The DC-DC converter according to claim 1, wherein the bootstrap boost circuit comprises a first diode and a first bootstrap capacitor;
a first end of the first diode is coupled to the input voltage end, and a second end of the first diode is respectively coupled to a first end of the first bootstrap capacitor and a first end of the high-side driver circuit through a first bootstrap node; and
a second end of the first bootstrap capacitor is respectively coupled to the switch node and a second end of the high-side driver circuit, and the first bootstrap capacitor is configured to be charged based on the input voltage when the PWM signal is at a low level, and provide the first boost voltage for the high-side driver circuit when the PWM signal is at a high level.

3. The DC-DC converter according to claim 2, wherein the charge pump boost circuit comprises the charge pump, a unidirectional rectifier circuit, a second bootstrap capacitor, and a high-voltage driver circuit;
the charge pump is configured to charge the second bootstrap capacitor to N times the input voltage through the unidirectional rectifier circuit, wherein N is a positive integer greater than 1;
a first end of the unidirectional rectifier circuit is coupled to the charge pump, and a second end of the unidirectional rectifier circuit is respectively coupled to a first end of the second bootstrap capacitor and a first end of the high-voltage driver circuit through a second bootstrap node;
a second end of the second bootstrap capacitor is coupled to the switch node, and the second bootstrap capacitor is configured to be charged based on the charge pump when the PWM signal is at the low level, and provide the second boost voltage for the high-voltage driver circuit when the PWM signal is at the high level and a voltage of the switch node rises to the input voltage; and
a second end of the high-voltage driver circuit is coupled to the control electrode of the high-side power transistor, and the high-voltage driver circuit is configured to output the second high-side driving voltage to the control electrode of the high-side power transistor based on the second boost voltage.

4. The DC-DC converter according to claim 3, wherein the unidirectional rectifier circuit comprises a unidirectional on switch tube.

5. The DC-DC converter according to claim 3, wherein the unidirectional rectifier circuit comprises a second diode.

6. The DC-DC converter according to claim 5, wherein when N is 3, the charge pump comprises a digital receiver, a first transistor, a second transistor, and a third transistor;
a first end of the digital receiver is coupled to the modulation signal end, a second end of the digital receiver is coupled to a bootstrap control signal end, a third end of the digital receiver is coupled to a control electrode of the first transistor, a fourth end of the digital receiver is coupled to a control electrode of the second transistor, and the digital receiver is configured to control on or off of the first transistor and the second transistor according to the PWM signal at the modulation signal end and a bootstrap control signal of the bootstrap control signal end;
a first electrode of the first transistor is respectively coupled to a first electrode of the second transistor, a first electrode of the third transistor and the second end of the first bootstrap capacitor, a second electrode of the first transistor is respectively coupled to the input voltage end and the first end of the first diode, and a second electrode of the second transistor is grounded; and
a control electrode of the third transistor is coupled to the modulation signal end, a second electrode of the third transistor is coupled to the switch node, and the PWM signal at the modulation signal end controls on or off of the third transistor.

7. The DC-DC converter according to claim 6, wherein the high-voltage driver circuit comprises a fourth transistor, a third diode, a fourth diode, and a third bootstrap capacitor;
a first end of the third bootstrap capacitor is respectively coupled to a second end of the third diode, a first end of the fourth diode and a control electrode of the fourth transistor, a second end of the third bootstrap capacitor is grounded, and the third bootstrap capacitor is configured to output a signal to the control electrode of the fourth transistor;
a first electrode of the fourth transistor is coupled to the control electrode of the high-side power transistor, a second electrode of the fourth transistor is coupled to the second bootstrap node, and the fourth transistor is configured to be turned on or off according to a voltage difference between the control electrode and the second electrode of the fourth transistor; and
a first end of the third diode is respectively coupled to the first bootstrap node and a first end of the second diode, and a second end of the fourth diode is respectively coupled to a second end of the second diode and the second bootstrap node.

8. The DC-DC converter according to claim 7, wherein,
when the PWM signal at the modulation signal end is at the low level, the bootstrap control signal at the bootstrap control signal end is a square signal, the first transistor and the second transistor are turned on, the third transistor is turned off, the high-side power transistor is turned off, the low-side power transistor is turned on, the first bootstrap capacitor is configured to charge the second bootstrap capacitor to twice the input voltage through the second diode, and charge the third bootstrap capacitor to twice the input voltage through the third diode, and the fourth transistor is turned off; and
when the PWM signal at the modulation signal end is at the high level, the first transistor and the second transistor are turned off, the third transistor is turned on, the high-side power transistor is turned on, the low-side power transistor is turned off, and the voltage of the switch node rises; and when the voltage of the switch node rises to a preset threshold, the fourth transistor is turned on, and when the voltage of the switch node rises to the input voltage, a voltage of an upper plate of the second bootstrap capacitor is raised to 3 times the input voltage, wherein the preset threshold is less than the input voltage.

9. The DC-DC converter according to claim 1, further comprising an output circuit, wherein one end of the output circuit is coupled to the switch node, and the output circuit is configured to generate an output voltage;
the output circuit comprises an inductor, an output capacitor, an equivalent series resistor, and an output resistor;
a first end of the inductor is coupled to the switch node, a second end of the inductor is respectively coupled to a first end of the equivalent series resistor, a first end of the output resistor and an output voltage end, and the output voltage is generated at the output voltage end according to an inductor current flowing through the inductor; and
a second end of the equivalent series resistor is coupled to the a first end of the output capacitor, and a second end of the output capacitor and a second end of the output resistor are grounded respectively.

10. The DC-DC converter according to claim 1, wherein,
the PWM signal is directly output to the control electrode of the high-side power transistor; or
the PWM signal is matched to a level converter of the high-side power transistor, and is output to the control electrode of the high-side power transistor through the level converter.

11. The DC-DC converter according to claim 1, wherein the second high-side driving voltage is greater than the first high-side driving voltage.

12. The DC-DC converter according to claim 2, wherein the first diode is a Schottky diode.

13. The DC-DC converter according to claim 6, wherein the first transistor is an enhanced Metal Oxide Semiconductor (MOS) transistor with P-type compensation.

14. The DC-DC converter according to claim 7, wherein the fourth transistor is an enhanced MOS transistor with P-type compensation, and the fourth transistor is a high Voltage P-channel Metal Oxide Semiconductor (HVPMOS) transistor.

15. A chip, comprising the DC-DC converter according to claim 1.

16. An electronic device, comprising the chip according to claim 15.
